(19) United States
(12) Patent Application Publication
(10) Pub. No.: US 2026/0063064 A1
(43) Pub. Date: Mar. 5, 2026

(54) OIL DEFLECTOR AND TURBOCHARGER

(71) Applicant: IHI Corporation, Tokyo (JP)

(72) Inventor: Mizuki TANAKA, Tokyo (JP)

(73) Assignee: IHI Corporation, Tokyo (JP)

(21) Appl. No.: 19/382,444

(22) Filed: Nov. 7, 2025

Related U.S. Application Data
(63) Continuation of application No. PCT/JP2024/019389, filed on May 27, 2024.

(30) Foreign Application Priority Data
Aug. 9, 2023 (JP) 2023-130279

(51) Int. Cl. F02B 39/14

(52) U.S. Cl. CPC F02B 39/14

(57) ABSTRACT

An oil deflector includes: a cylindrical portion; a first guide surface extending radially outward from an outer circumferential surface of the cylindrical portion; two second guide surfaces extending radially outward from the outer circumferential surface, connected to the first guide surface in a circumferential direction, and arranged symmetrically with respect to a symmetry axis; two first claw portions extending radially outward from the first guide surface, arranged symmetrically with respect to the symmetry axis, and having a central portion in the circumferential direction positioned on a side opposite to the second guide surface with respect to an orthogonal axis; and two second claw portions extending radially outward from the first guide surface, arranged symmetrically with respect to the symmetry axis, and having a central portion in the circumferential direction positioned on a side of the second guide surface with respect to the orthogonal axis.

### CROSS REFERENCE TO RELATED APPLICATIONS

This application is a continuation application of International Application No. PCT/JP2024/019389, filed on May 27, 2024, which claims priority to Japanese Patent Application No. 2023-130279, filed on Aug. 9, 2023, the entire contents of which are incorporated by reference herein.

### BACKGROUND ART

### Technical Field

The present disclosure relates to an oil deflector and a turbocharger. The present application claims the benefit of priority based on Japanese Patent Application No. 2023-130279 filed on Aug. 9, 2023, the content of which is incorporated herein.

### Related Art

In various devices, a bearing that pivotally supports a shaft is used. For example, Patent Literature 1 discloses a turbocharger including a bearing that pivotally supports a shaft. Lubricating oil is supplied to a bearing used in a turbocharger or the like.

### CITATION LIST

### Patent Literature

Patent Literature 1: Japanese Patent No. 5807436

### SUMMARY

### Technical Problem

Lubricating oil supplied to the inside of a bearing scatters from a thrust bearing surface of the bearing as a shaft rotates. The lubricating oil scattered from the bearing is blocked by an oil deflector and guided to an oil discharge port of a housing. The oil deflector is attached to the housing, for example, by press-fitting claw portions provided on an outer peripheral portion of the oil deflector. It is desired to improve coaxiality of the oil deflector for attachment of the oil deflector using the claw portions.

The object of the present disclosure is to provide an oil deflector and a turbocharger capable of improving the coaxiality of the oil deflector.

### Solution to Problem

In order to solve the above-mentioned problem, an oil deflector according to the present disclosure includes: a cylindrical portion; a first guide surface extending radially outward from an outer circumferential surface of the cylindrical portion, the first guide surface formed over a range greater than or equal to 180° in a circumferential direction of the cylindrical portion; two second guide surfaces extending radially outward from the outer circumferential surface of the cylindrical portion, extending in a direction intersecting the outer circumferential surface of the cylindrical portion and the first guide surface, and connected to respective ends of the first guide surface in the circumferential direction, the two second guide surfaces arranged symmetrically with respect to a symmetry axis orthogonal to a central axis of the cylindrical portion when viewed in an axial direction of the cylindrical portion; and a total of four claw portions including two first claw portions and two second claw portions, the two first claw portions extending radially outward from the first guide surface and, when viewed in the axial direction, arranged symmetrically with respect to the symmetry axis and having a central portion in the circumferential direction positioned on a side opposite to the second guide surface with respect to an orthogonal axis passing through the central axis and orthogonal to the symmetry axis, the two second claw portions extending radially outward from the first guide surface and, when viewed in the axial direction, arranged symmetrically with respect to the symmetry axis and having a central portion in the circumferential direction positioned on a side of the second guide surface with respect to the orthogonal axis.

An angle in the circumferential direction from the orthogonal axis to the central portion in the circumferential direction of a first claw portion may be greater than an angle in the circumferential direction from the orthogonal axis to the central portion in the circumferential direction of a second claw portion.

The circumferential length of a first claw portion may be shorter than the circumferential length of a second claw portion.

The oil deflector covers an outer peripheral edge of an oil thrower member, and the circumferential length of the first claw portion, the circumferential length of the second claw portion, the angle in the circumferential direction from the orthogonal axis to the central portion in the circumferential direction of the first claw portion, and the angle in the circumferential direction from the orthogonal axis to the central portion in the circumferential direction of the second claw portion may satisfy a relationship expressed by the following Inequation (1).

0.113×(L1×sin θ1−L2×sin θ2)<2×C (1)
Wherein,
L1: Circumferential length of the first claw portion,
L2: Circumferential length of the second claw portion,
θ1: Angle in the circumferential direction from the orthogonal axis to the central portion in the circumferential direction of the first claw portion,
θ2: Angle in the circumferential direction from the orthogonal axis to the central portion in the circumferential direction of the second claw portion, and
C: Clearance between the oil deflector and the oil thrower member.

In order to solve the above-mentioned problem, a turbocharger of the present disclosure includes the oil deflector described above.

### Effects

According to the present disclosure, the coaxiality of the oil deflector can be improved.

### BRIEF DESCRIPTION OF DRAWINGS

FIG. 1 is a schematic cross-sectional view of a turbocharger of the present embodiment.

FIG. 2 is a diagram extracted from a one-dot chain line part of FIG. 1.

FIG. 3 is a front view of an oil deflector according to the present embodiment as viewed from a bearing side.

FIG. 4 is a diagram for explaining details of claw portions in the oil deflector according to the present embodiment.

### DESCRIPTION OF EMBODIMENTS

An embodiment of the present disclosure will be described below by referring to the accompanying drawings. Dimensions, materials, other specific numerical values, and the like illustrated in the embodiment are merely examples for facilitating understanding, and the present disclosure is not limited thereto unless otherwise specified. Note that, in the present specification and the drawings, components having substantially the same function and structure are denoted by the same symbol, and redundant explanations are omitted. Illustration of components not directly related to the present disclosure is omitted.

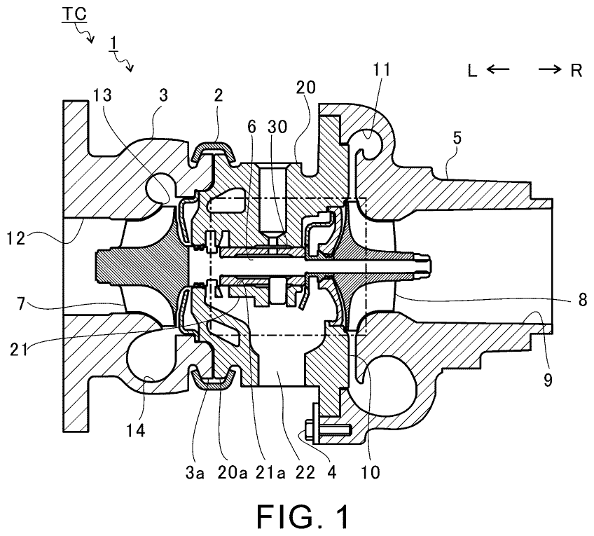

FIG. 1 is a schematic cross-sectional view of a turbocharger TC of the present embodiment. Hereinafter, description is given on the premise that the direction of an arrow L illustrated in FIG. 1 is the left side of the turbocharger TC. Description is given on the premise that the direction of an arrow R illustrated in FIG. 1 is the right side of the turbocharger TC. As illustrated in FIG. 1, the turbocharger TC includes a turbocharger main body 1. The turbocharger main body 1 includes a bearing housing 20. A turbine housing 3 is connected to the left side of the bearing housing 20 by a fastening mechanism 2. A compressor housing 5 is connected to the right side of the bearing housing 20 by a fastening bolt 4. The bearing housing 20, the turbine housing 3, and the compressor housing 5 are integrated.

A protrusion 20a is formed on the outer circumferential surface of the bearing housing 20. The protrusion 20a is formed in the vicinity of the turbine housing 3. The protrusion 20a protrudes in a radial direction of the bearing housing 20. A protrusion 3a is formed on the outer circumferential surface of the turbine housing 3. The protrusion 3a is formed in the vicinity of the bearing housing 20. The protrusion 3a protrudes in a radial direction of the turbine housing 3. The bearing housing 20 and the turbine housing 3 are attached to each other by fastening the protrusions 20a and 3a by the fastening mechanism 2. The fastening mechanism 2 includes, for example, a G coupling which clamps the protrusions 20a and 3a.

The bearing housing 20 has a bearing wall 21. A bearing hole 21a is formed in the bearing wall 21. The bearing hole 21a penetrates through the turbocharger TC in the left-right direction. A bearing 30 is provided in the bearing hole 21a. In FIG. 1, a semi-floating bearing is illustrated as an example of the bearing 30. Note that the bearing 30 may be another bearing as long as it has at least a thrust bearing surface. A shaft 6 is pivotally supported by the bearing 30 in a freely rotatable manner. At the left end of the shaft 6, a turbine blade wheel 7 is assembled. The turbine blade wheel 7 is housed in the turbine housing 3 in a freely rotatable manner. A compressor impeller 8 is assembled to the right end of the shaft 6. The compressor impeller 8 is housed in the compressor housing 5 in a freely rotatable manner. A discharge port 22 for discharging the lubricating oil scattered from the bearing 30 is formed in a lower portion of the bearing housing 20.

An intake port 9 is formed in the compressor housing 5. The intake port 9 opens to the right side of the turbocharger TC. The intake port 9 is connected to an air cleaner (not illustrated). Facing surfaces of the bearing housing 20 and the compressor housing 5 constitute a diffuser flow path 10. The diffuser flow path 10 is annularly formed outward from an inner side in the radial direction of the shaft 6. The diffuser flow path 10 communicates with the intake port 9 via the compressor impeller 8 on the aforementioned inner side in the radial direction.

The compressor housing 5 includes a compressor scroll flow path 11. The compressor scroll flow path 11 is annular. The compressor scroll flow path 11 is, for example, positioned on the outer side in the radial direction of the shaft 6 with respect to the diffuser flow path 10. The compressor scroll flow path 11 communicates with an intake port of an engine (not illustrated). The compressor scroll flow path 11 also communicates with the diffuser flow path 10.

When the compressor impeller 8 rotates, the air is sucked from the intake port 9 into the compressor housing 5. The sucked air is pressurized and accelerated in the process of flowing between blades of the compressor impeller 8. The pressurized and accelerated air is further pressurized by the diffuser flow path 10 and the compressor scroll flow path 11. The pressurized air is guided to the intake port of the engine.

A discharge port 12 is formed in the turbine housing 3. The discharge port 12 opens to the left side of the turbocharger TC. The discharge port 12 is connected to an exhaust gas purification device (not illustrated). The turbine housing 3 includes a flow path 13 and a turbine scroll flow path 14. The turbine scroll flow path 14 is annular. The turbine scroll flow path 14 is positioned, for example, on an outer side in the radial direction of the turbine blade wheel 7 with respect to the flow path 13. The turbine scroll flow path 14 communicates with a gas inlet port (not illustrated). Exhaust gas discharged from an exhaust manifold of the engine (not illustrated) is guided into the gas inlet port. The turbine scroll flow path 14 also communicates with the turbine blade wheel 7 via the aforementioned flow path 13.

The exhaust gas guided from the gas inlet port to the turbine scroll flow path 14 is guided to the discharge port 12 via the flow path 13 and the turbine blade wheel 7. The exhaust gas guided to the discharge port 12 rotates the turbine blade wheel 7 in the process of flowing therethrough. The turning force of the turbine blade wheel 7 is transmitted to the compressor impeller 8 via the shaft 6. As described above, the air is pressurized by the turning force of the compressor impeller 8 and guided to the intake port of the engine.

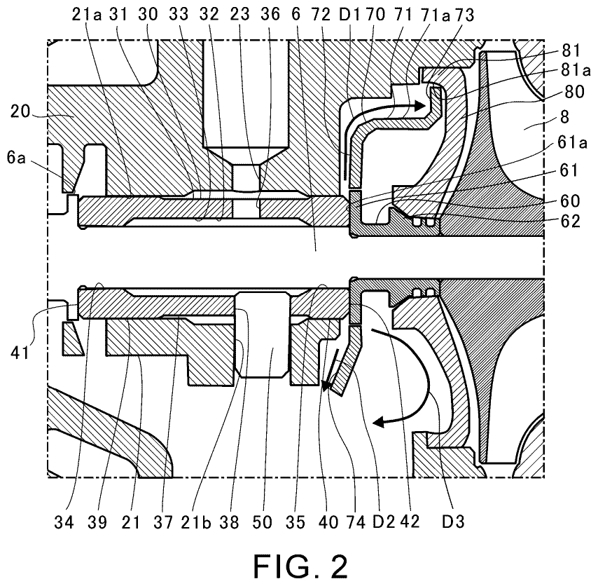

FIG. 2 is an extracted diagram of an alternate long and short dash line portion of FIG. 1. As illustrated in FIG. 2, an oil passage 23 is formed in the bearing housing 20. The oil passage 23 penetrates from the outside of the bearing housing 20 to the bearing hole 21a. Lubricating oil flows into the bearing hole 21a from the oil passage 23. An insertion hole 32 is formed in a main body 31 of the bearing 30. The insertion hole 32 penetrates through the main body 31 in the axial direction of the bearing 30. The central axis of the bearing 30 extends in the left-right direction. The shaft 6 is inserted through the insertion hole 32. On the inner circumferential surface 33 of the main body 31, two radial bearing surfaces 34 and 35 are formed. The radial bearing surfaces 34 and 35 are spaced apart in the axial direction of the bearing 30.

An oil hole 36 is formed in the main body 31 of the bearing 30. The oil hole 36 penetrates through the main body 31 from the inner circumferential surface 33 of the main body 31 to the outer circumferential surface 37 of the main body 31. A part of the lubricating oil supplied to the bearing hole 21a flows into the inner circumferential surface 33 through the oil hole 36. The lubricating oil flowed in spreads to left and right in FIG. 2 from the oil hole 36. The spread lubricating oil is supplied to gaps between the shaft 6 and the radial bearing surfaces 34 and 35. The shaft 6 is pivotally supported by the oil film pressure of the lubricating oil supplied to the gaps between the shaft 6 and the radial bearing surfaces 34 and 35.

A through hole 38 is formed in the main body 31 of the bearing 30. The through hole 38 penetrates through the main body 31 from the inner circumferential surface 33 of the main body 31 to the outer circumferential surface 37 of the main body 31. A pin hole 21b is formed in the bearing wall 21. The pin hole 21b is formed at a portion facing the through hole 38. The pin hole 21b penetrates through a wall forming the bearing hole 21a. A positioning pin 50 is fitted to the pin hole 21b from the lower side in FIG. 2. The head of the positioning pin 50 is inserted into the through hole 38 of the bearing 30. The positioning pin 50 regulates rotation and movement in the axial direction of the bearing 30.

An oil thrower member 60 is attached to the shaft 6. The oil thrower member 60 is disposed on the compressor impeller 8 side which is the right side in FIG. 2 with respect to the main body 31. The oil thrower member 60 has a substantially cylindrical shape. The inner circumferential surface of the oil thrower member 60 is fitted to the outer circumferential surface of the shaft 6. The oil thrower member 60 scatters the lubricating oil flowing to the compressor impeller 8 side along the shaft 6 to the outer side in the radial direction. The oil thrower member 60 suppresses leakage of the lubricating oil to the compressor impeller 8 side.

On the bearing 30 side, which is the left side in FIG. 2, of the oil thrower member 60, a first enlarged diameter portion 61 expanding in diameter radially outward is included. A facing surface 61a, which is the left end surface of the first enlarged diameter portion 61, faces the main body 31 of the bearing 30 in the axial direction. A second enlarged diameter portion 62 expanding in diameter radially outward is included on the compressor impeller 8 side, which is the right side in FIG. 2, of the oil thrower member 60. The outer circumferential surface of the second enlarged diameter portion 62 is covered with a seal plate 80 described later.

The shaft 6 has a large diameter portion 6a. The large diameter portion 6a is positioned on the turbine blade wheel 7 side, which is the left side in FIG. 2, with respect to the main body 31 of the bearing 30. The large diameter portion 6a axially faces the main body 31.

As described above, movement of the main body 31 of the bearing 30 in the axial direction is restricted by the positioning pin 50. The main body 31 is interposed between the oil thrower member 60 and the large diameter portion 6a of the shaft 6 in the axial direction. Lubricating oil is supplied to a gap between the main body 31 and the oil thrower member 60 and to a gap between the main body 31 and the large diameter portion 6a. When the shaft 6 moves in the axial direction, the oil thrower member 60 or the large diameter portion 6a is supported by the oil film pressure with respect to the main body 31.

In the bearing 30, both axial end surfaces of the main body 31 are thrust bearing surfaces 41 and 42. The thrust bearing surfaces 41 and 42 receive a thrust load. Of the thrust bearing surfaces 41 and 42, the left thrust bearing surface 41 faces the large diameter portion 6a of the shaft 6. The right thrust bearing surface 42 of the thrust bearing surfaces 41 and 42 faces the oil thrower member 60.

Damper portions 39 and 40 are formed on the outer circumferential surface of the main body 31 on both end sides in the axial direction. The damper portions 39 and 40 suppress vibration of the shaft 6 by the oil film pressure of the lubricating oil supplied to the gap with respect to the inner circumferential surface of the bearing hole 21a.

An oil deflector 70 is provided on the right side of a thrust bearing surface 42 of the bearing 30. The oil deflector 70 has a substantially cylindrical shape. The oil deflector 70 is disposed coaxially with the bearing 30. The oil deflector 70 covers the outer peripheral edge of the oil thrower member 60. Specifically, the outer peripheral edge of the first enlarged diameter portion 61 of the oil thrower member 60 is covered with the oil deflector 70. The oil thrower member 60 is rotatable relative to the oil deflector 70.

The oil deflector 70 is attached to the seal plate 80. The seal plate 80 seals between the outer circumferential surface of the oil thrower member 60 and the inner wall surface of the bearing housing 20. The seal plate 80 has a substantially annular disk shape. The inner circumferential surface of the seal plate 80 faces the outer circumferential surface of the second enlarged diameter portion 62 of the oil thrower member 60 in the radial direction. The outer circumferential surface of the seal plate 80 is fitted to the inner circumferential surface of the bearing housing 20. On the outer peripheral edge of the seal plate 80, an annular protruding portion 81 protruding toward the bearing 30, which is on the left side in FIG. 2, is included. As described later, the oil deflector 70 is attached to the inner circumferential surface 81a of the annular protruding portion 81.

The seal plate 80 suppresses leakage of lubricating oil from a space in the bearing housing 20 to a space in the compressor housing 5. The lubricating oil scattered from the thrust bearing surface 42 of the bearing 30 is blocked by the oil deflector 70 and guided to the discharge port 22 (see FIG. 1) in the lower portion of the bearing housing 20. As a result, leakage of the lubricating oil to the compressor impeller 8 side is more effectively suppressed.

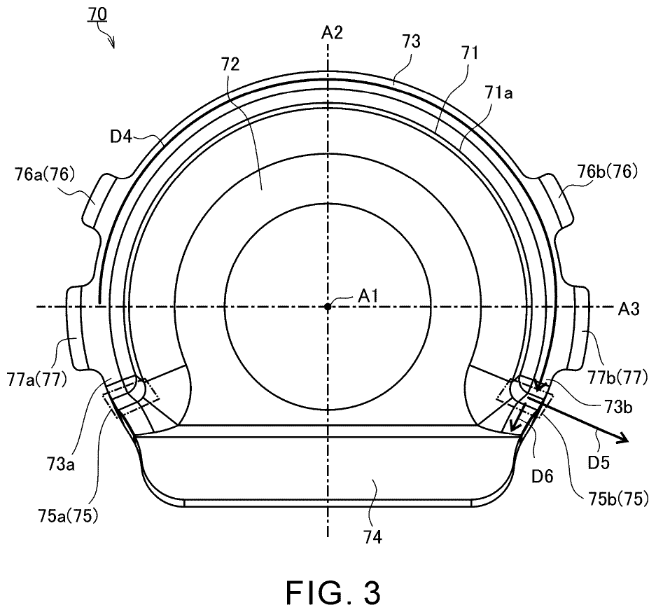

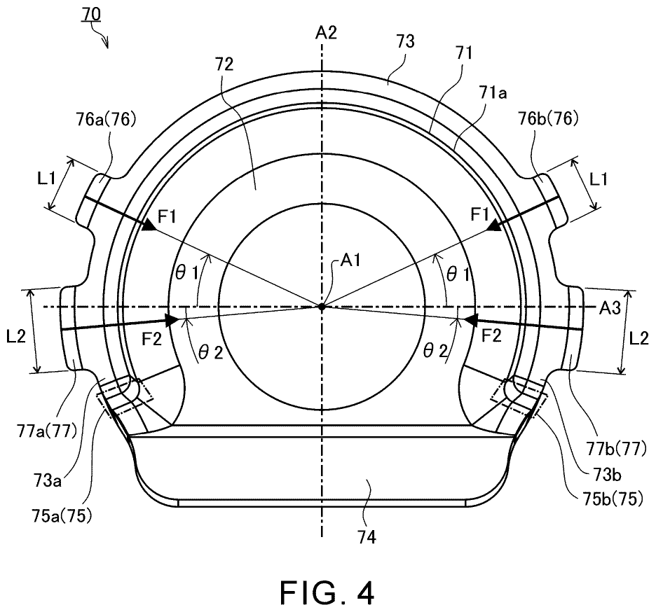

Hereinafter, the oil deflector 70 will be described in detail with reference to FIGS. 3 and 4 in addition to FIG. 2. FIG. 3 is a front view of the oil deflector 70 according to the present embodiment as viewed from the bearing 30 side. In FIGS. 2 and 3, the flow of the lubricating oil scattered from the thrust bearing surface 42 of the bearing 30 is indicated by arrows D1, D2, D3, D4, D5, and D6.

As illustrated in FIGS. 2 and 3, the oil deflector 70 includes a cylindrical portion 71, a flat portion 72, a first guide surface 73, an inclined surface 74, and two second guide surfaces 75 of a second guide surface 75a and a second guide surface 75b. The oil deflector 70 is integrally formed by press working, for example. However, the oil deflector 70 may be formed by joining a plurality of members.

The cylindrical portion 71 is disposed coaxially with the bearing 30. Therefore, the central axis A1 of the cylindrical portion 71 illustrated in FIG. 3 is basically coaxial with the central axis of the bearing 30. However, as will be described later, in consideration of the coaxiality of the oil deflector 70, strictly speaking, the central axis A1 of the cylindrical portion 71 can shift from the central axis of the bearing 30. The flat portion 72 extends radially inward from the left end of the cylindrical portion 71. The flat portion 72 has an annular flat plate shape. The flat portion 72 covers the outer peripheral edge of the oil thrower member 60. Specifically, the inner peripheral portion of the flat portion 72 covers the outer peripheral edge of the first enlarged diameter portion 61 of the oil thrower member 60.

Hereinafter, the axial direction, the circumferential direction, and the radial direction of the cylindrical portion 71 are also simply referred to as the axial direction, the circumferential direction, and the radial direction, respectively. The axial direction, the circumferential direction, and the radial direction of the cylindrical portion 71 correspond to the axial direction, the circumferential direction, and the radial direction of the oil deflector 70, respectively.

The first guide surface 73 extends radially outward from the outer circumferential surface 71a of the cylindrical portion 71. Specifically, the first guide surface 73 extends radially outward from the right end side in FIG. 2 of the outer circumferential surface 71a of the cylindrical portion 71. The first guide surface 73 is formed over a range of greater than or equal to 180° in the circumferential direction of the cylindrical portion 71. The first guide surface 73 extends in an arc shape in the circumferential direction of the cylindrical portion 71. The first guide surface 73 faces the bearing 30 side, which is the left side in FIG. 2.

The inclined surface 74 is included at a lower portion of the left end in FIG. 2 of the cylindrical portion 71. The inclined surface 74 extends downward from a lower portion of the flat portion 72. The inclined surface 74 is inclined to the left side in FIG. 2 as it extends in the radially outward direction of the cylindrical portion 71. That is, the inclined surface 74 is inclined in a direction away from the first guide surface 73 as it extends in the radially outward direction of the cylindrical portion 71.

As indicated by an arrow D1 in FIG. 2, a part of the lubricating oil scattered from the thrust bearing surface 42 of the bearing 30 is guided to the first guide surface 73 along the outer circumferential surface 71a of the cylindrical portion 71. The lubricating oil guided to the first guide surface 73 is guided in the circumferential direction along the first guide surface 73 as indicated by the arrow D4 in FIG. 3. The flow of the lubricating oil along the first guide surface 73 (namely, the flow indicated by the arrow D4) is referred to as an inner flow. The direction of the inner flow indicated by the arrow D4 coincides with the rotation direction of the shaft 6. That is, the arrow D4 indicates the inner flow when the shaft 6 rotates clockwise in FIG. 3.

As indicated by the arrow D2 in FIG. 2, a part of the lubricating oil scattered from the thrust bearing surface 42 of the bearing 30 is sent downward along the inclined surface 74. The lubricating oil sent downward along the inclined surface 74 is guided to the discharge port 22 (see FIG. 1) in the lower portion of the bearing housing 20.

Here, as indicated by the arrow D3 in FIG. 2, a part of the lubricating oil scattered from the thrust bearing surface 42 of the bearing 30 is discharged to the compressor impeller 8 side through a gap between the oil thrower member 60 and the oil deflector 70. The lubricating oil having passed through the gap between the oil thrower member 60 and the oil deflector 70 scatters radially outward as the oil thrower member 60 rotates. The flow of the lubricating oil radially scattering after passing through the gap between the oil thrower member 60 and the oil deflector 70 (namely, the flow indicated by the arrow D3) is referred to as an outer flow.

The inner flow indicated by the arrow D4 in FIG. 3 and the outer flow indicated by the arrow D3 in FIG. 2 may merge in the vicinity of the lower portion of the oil deflector 70 and interfere with each other. The interference between the inner flow and the outer flow causes a decrease in the oil discharge performance for the lubricating oil and deterioration in the oil sealing performance. In the oil deflector 70 of the present embodiment, since the second guide surfaces 75a and 75b are included, the interference between the inner flow and the outer flow is suppressed.

As illustrated in FIG. 3, the second guide surfaces 75a and 75b extend radially outward from the outer circumferential surface 71a of the cylindrical portion 71. The second guide surfaces 75a and 75b extend in a direction intersecting the outer circumferential surface 71a of the cylindrical portion 71 and the first guide surface 73. The second guide surfaces 75a and 75b are connected with the outer circumferential surface 71a of the cylindrical portion 71 and the first guide surface 73. The second guide surface 75a is connected with an end 73a on one side in the circumferential direction of the first guide surface 73. The second guide surface 75b is connected with an end 73b on the other side in the circumferential direction of the first guide surface 73.

The second guide surfaces 75a and 75b are formed between the first guide surface 73 and the inclined surface 74. That is, the first guide surface 73 and the inclined surface 74 are connected to each other via the second guide surfaces 75a and 75b. The second guide surface 75a is formed between the end 73a of the first guide surface 73 and the left end of the inclined surface 74 in FIG. 3. The second guide surface 75b is formed between the end 73b of the first guide surface 73 and the right end of the inclined surface 74 in FIG. 3.

The second guide surfaces 75a and 75b are provided at different positions in the circumferential direction of the cylindrical portion 71. Specifically, as illustrated in FIG. 3, the second guide surfaces 75a and 75b are arranged symmetrically with respect to a symmetry axis A2 orthogonal to the central axis A1 of the cylindrical portion 71 when viewed in the axial direction of the cylindrical portion 71. In the example of FIG. 3, the symmetry axis A2 extends in a vertical direction. Therefore, the second guide surfaces 75a and 75b are positioned on the lower side of the oil deflector 70. Specifically, when viewed in the axial direction of the cylindrical portion 71, the second guide surfaces 75a and 75b are positioned below an orthogonal axis A3 that passes through the central axis A1 and is orthogonal to the symmetry axis A2. The second guide surfaces 75a and 75b are positioned above the inclined surface 74. However, the symmetry axis A2 may be inclined with respect to the vertical direction.

In the example of FIG. 3, the second guide surfaces 75a and 75b extend substantially parallel to the axial direction of the cylindrical portion 71 and substantially parallel to the radial direction of the cylindrical portion 71. Specifically, the second guide surfaces 75a and 75b are slightly inclined such that the bearing 30 side is lower than the first guide surface 73 side.

As described above, the inner flow indicated by the arrow D4 is a flow of the lubricating oil along the first guide surface 73. Incidentally, the second guide surfaces 75a and 75b are located on the path of the inner flow and extend in a direction intersecting the direction of the inner flow. Therefore, the lubricating oil sent by the inner flow collides with any one of the second guide surfaces 75a and 75b. Thus, the flow direction of the lubricating oil changes. In the example of FIG. 3, the lubricating oil sent by the inner flow indicated by the arrow D4 collides with the second guide surface 75b. However, in a case where the shaft 6 rotates counterclockwise in FIG. 3, the flow direction of the inner flow is opposite to the direction of the arrow D4, and thus the lubricating oil sent by the inner flow collides with the second guide surface 75a.

As indicated by the arrow D5 in FIG. 3, the lubricating oil having collided with the second guide surface 75b is guided in the radially outward direction of the cylindrical portion 71 by the second guide surface 75b and scatters. This prevents the lubricating oil from being sent to the vicinity of the lower portion of the oil deflector 70 along the direction of the inner flow. This prevents the inner flow and the outer flow from merging in the vicinity of the lower portion of the oil deflector 70 and interfering with each other. Therefore, the oil discharge performance of the lubricating oil is improved, which improves the oil sealing performance.

As indicated by an arrow D6 in FIG. 3, a part of the lubricating oil having collided with the second guide surface 75b is also guided to the bearing 30 side in the axial direction of the cylindrical portion 71 by the second guide surface 75b and scatters. The lubricating oil scattered in the axial direction of the cylindrical portion 71 by the second guide surface 75b is sent downward along the inclined surface 74. This further improves the oil discharge performance. In particular, in the oil deflector 70, the first guide surface 73 and the inclined surface 74 are connected to each other via the second guide surface 75b. Therefore, the lubricating oil scattered in the axial direction of the cylindrical portion 71 by the second guide surface 75b is easily guided to the inclined surface 74.

In the oil deflector 70, the two second guide surfaces 75a and 75b are provided at different positions in the circumferential direction of the cylindrical portion 71. As a result, regardless of the rotation direction of the shaft 6, the lubricating oil sent by the inner flow collides with either one of the second guide surfaces 75a and 75b. The inner flow and the outer flow are prevented from merging in the vicinity of the lower portion of the oil deflector 70 and interfering with each other regardless of the rotation direction of the shaft 6.

As described above, the oil deflector 70 is attached to the seal plate 80 of FIG. 2. As illustrated in FIG. 3, the first guide surface 73 is provided with two first claw portions 76 of a first claw portion 76a and a first claw portion 76b and two second claw portions 77 of a second claw portion 77a and a second claw portion 77b as claw portions protruding in the radially outward direction of the cylindrical portion 71. A total of four claw portions are press-fitted into the inner circumferential surface 81a of the annular protruding portion 81 of the seal plate 80, whereby the oil deflector 70 is attached to the seal plate 80.

However, the oil deflector 70 is only required to be attached to the bearing housing 20 by press-fitting the claw portions. For example, the claw portions may be press-fitted into a member other than the seal plate 80. Furthermore, for example, the claw portions may be directly press-fitted into the bearing housing 20.

In attaching the oil deflector 70 using the claw portions, the attachment position of the oil deflector 70 is determined in a state where a force is acting on each of the claw portions. Depending on the balance of forces acting on the claw portions, the coaxiality of the oil deflector 70 may deteriorate. Deterioration of the coaxiality of the oil deflector 70 may contribute to interference between the oil deflector 70 and the oil thrower member 60 or to a locally large clearance between the oil deflector 70 and the oil thrower member 60, thereby deteriorating the oil seal performance. In the present embodiment, it is possible to improve the coaxiality of the oil deflector 70 by devising the claw portions of the oil deflector 70.

FIG. 4 is a diagram for explaining details of the claw portions in the oil deflector 70 according to the present embodiment. As illustrated in FIG. 4, in the oil deflector 70, a total of four claw portions of the first claw portion 76a, the first claw portion 76b, the second claw portion 77a, and the second claw portion 77b, are included at intervals in the circumferential direction.

The first claw portions 76a and 76b extend radially outward from the first guide surface 73. The first claw portions 76a and 76b extend on the same plane as the first guide surface 73 and are connected with the outer edge portion of the first guide surface 73. The first claw portions 76a and 76b have a substantially rectangular flat plate shape. The first claw portions 76a and 76b are arranged symmetrically with respect to the symmetry axis A2 when viewed in the axial direction of the cylindrical portion 71. The central portions of the first claw portions 76a and 76b in the circumferential direction are positioned on the opposite side of the second guide surfaces 75a and 75b with respect to the orthogonal axis A3 when viewed in the axial direction of the cylindrical portion 71. Therefore, in the example of FIG. 4, the central portions of the first claw portions 76a and 76b in the circumferential direction are positioned above the orthogonal axis A3 when viewed in the axial direction of the cylindrical portion 71. The central portions of the first claw portions 76 in the circumferential direction may be, for example, the center of gravity of the first claw portion 76, or may be the centroid of the first claw portion 76 when viewed in the axial direction of the cylindrical portion 71.

The second claw portions 77a and 77b extend radially outward from the first guide surface 73. The second claw portions 77a and 77b extend on the same plane as the first guide surface 73 and are connected with the outer edge portion of the first guide surface 73. The second claw portions 77a and 77b have a substantially rectangular flat plate shape. The second claw portions 77a and 77b are arranged symmetrically with respect to the symmetry axis A2 when viewed in the axial direction of the cylindrical portion 71. The central portions of the second claw portions 77a and 77b in the circumferential direction are positioned on the side of the second guide surfaces 75a and 75b with respect to the orthogonal axis A3 when viewed in the axial direction of the cylindrical portion 71. Therefore, in the example of FIG. 4, the central portions of the second claw portions 77a and 77b in the circumferential direction are positioned below the orthogonal axis A3 when viewed in the axial direction of the cylindrical portion 71. The central portions of the second claw portions 77 in the circumferential direction may be, for example, the center of gravity of the second claw portion 77, or may be the centroid of the second claw portion 77 when viewed in the axial direction of the cylindrical portion 71.

As illustrated in FIG. 4, a force F1 in a direction from the central portion in the circumferential direction of each of the first claw portions 76 toward the central axis A1 acts on the first claw portion 76. A force F2 in a direction from the central portion in the circumferential direction of each of the second claw portions 77 toward the central axis A1 acts on the second claw portion 77. In FIG. 4, the magnitude and the direction of the forces F1 and the force F2 are represented by vectors.

The central axis A1 of the oil deflector 70 is likely to deviate from the ideal position in the direction of a resultant force of the force F1 acting on each of the first claw portions 76 and the force F2 acting on each of the second claw portions 77. The amount of deviation of the central axis A1 of the oil deflector 70 from the ideal position is likely to increase as the resultant force of the force F1 acting on each of the first claw portions 76 and the force F2 acting on each of the second claw portions 77 increases.

As described above, in the oil deflector 70, the second guide surfaces 75a and 75b are provided below the orthogonal axis A3. Therefore, the second claw portions 77a and 77b cannot be arranged below the second guide surfaces 75a and 75b. Therefore, an upward component of the force F2 acting on the second claw portions 77 tends to be small.

Let us assume a case where one claw portion extending radially outward from a portion immediately above the first guide surface 73 (namely, a portion overlapping the symmetry axis A2 when viewed in the axial direction of the cylindrical portion 71) is provided instead of the two first claw portions 76. In this case, a total of three claw portions including the one claw portion provided immediately above the oil deflector 70 and the two second claw portions 77 are press-fitted into the seal plate 80. A force acting on the one claw portion provided immediately above the oil deflector 70 has only a downward component. Therefore, the direction of a resultant force of the forces acting on the three claw portions tends to be downward. In addition, the downward component of the resultant force tends to be large. Accordingly, the central axis A1 of the oil deflector 70 is likely to deviate downward with respect to the ideal position.

As described above, the oil deflector 70 according to the present embodiment includes the total of four claw portions including the first claw portions 76a and 76b provided on the upper side of the oil deflector 70 with respect to the orthogonal axis A3 and the second claw portions 77a and 77b provided on the lower side of the oil deflector 70 with respect to the orthogonal axis A3. Then, the total of the four claw portions are press-fitted into the seal plate 80. The force F1 acting on the first claw portions 76 has not only a downward component but also a left-right component in FIG. 4. Therefore, the downward component of the resultant force of the forces F1 acting on the two respective first claw portions 76a and 76b tends to be smaller than the force acting on the one claw portion of the case where the one claw portion is provided immediately above the oil deflector 70 instead of the two first claw portions 76. Therefore, the difference between the downward component of the resultant force of the forces F1 respectively acting on the two first claw portions 76a and 76b and an upward component of a resultant force of the forces F2 respectively acting on the two second claw portions 77a and 77b can be reduced.

Accordingly, the amount of deviation of the central axis A1 of the oil deflector 70 from the ideal position can be reduced, and thus the coaxiality of the oil deflector 70 can be improved. As a result, it is possible to suppress interference between the oil deflector 70 and the oil thrower member 60, deterioration in the oil seal performance due to local increase in clearance between the oil deflector 70 and the oil thrower member 60, and others.

In particular, in the oil deflector 70 according to the present embodiment, a circumferential angle θ1 from the orthogonal axis A3 to the central portion in the circumferential direction of a first claw portion 76 is greater than a circumferential angle θ2 from the orthogonal axis A3 to the central portion in the circumferential direction of a second claw portion 77.

When viewed in the axial direction of the cylindrical portion 71, the angle θ1 is an angle formed by the orthogonal axis A3 and a line segment connecting the central axis A1 and the central portion in the circumferential direction of a first claw portion 76. When viewed in the axial direction of the cylindrical portion 71, the angle θ2 is an angle formed by the orthogonal axis A3 and a line segment connecting the central axis A1 and the central portion in the circumferential direction of a second claw portion 77.

As described above, the second claw portions 77a and 77b cannot be disposed below the second guide surfaces 75a and 75b. Therefore, there is a constraint that it is difficult to increase the angle θ2. On the other hand, the positions of the first claw portions 76a and 76b can be freely set on the first guide surface 73 above the orthogonal axis A3. Therefore, there is a high degree of freedom for the angle θ1.

When a first claw portion 76 and a second claw portion 77 approach each other, it becomes easier for the oil deflector 70 to turn about the orthogonal axis A3. For example, in a case where a total of two claw portions are provided in the left and right portions of the oil deflector 70 (specifically, two positions on the right and left sides on the orthogonal axis A3 in FIG. 4) instead of the first claw portions 76a and 76b and the second claw portions 77a and 77b, it becomes easier for the oil deflector 70 to turn about the orthogonal axis A3. The closer the first claw portions 76 and the second claw portions 77 are to each other, it becomes more likely to be in this situation.

On the other hand, as illustrated in FIG. 4, by setting the angle θ1 to be greater than the angle θ2, the first claw portions 76 and the second claw portions 77 can be separated away from each other. This can suppress the oil deflector 70 from turning about the orthogonal axis A3, thereby stabilizing the attitude of the oil deflector 70.

Incidentally, the angle θ1 may coincide with the angle θ2 or may be smaller than the angle θ2.

In particular, in the oil deflector 70 according to the present embodiment, a circumferential length L1 of a first claw portion 76 is shorter than a circumferential length L2 of a second claw portion 77.

The outer peripheral edge of a first claw portion 76 extends in the circumferential direction of the cylindrical portion 71. Almost the entire outer peripheral edge of the first claw portion 76 is press-fitted into the seal plate 80. That is, the circumferential length of the portion of the first claw portion 76 that is press-fitted into the seal plate 80 is the length L1. The outer peripheral edge of a second claw portion 77 extends in the circumferential direction of the cylindrical portion 71. Almost the entire outer peripheral edge of the second claw portion 77 is press-fitted into the seal plate 80. That is, the circumferential length of the portion of the second claw portion 77 that is press-fitted into the seal plate 80 is the length L2.

The magnitude of the force acting on a claw portion is substantially proportional to the size of the portion of the claw portion that is press-fitted into the seal plate 80. Therefore, the magnitude of the force F1 acting on the first claw portions 76 is substantially proportional to the length L1. Meanwhile, the magnitude of the force F2 acting on the second claw portions 77 is substantially proportional to the length L2.

As described above, since the second claw portions 77a and 77b cannot be arranged below the second guide surfaces 75a and 75b, the upward component of the forces F2 acting on the second claw portions 77 tends to be small. Therefore, the downward components of the forces F1 acting on the first claw portions 76 tend to be greater than the upward components of the forces F2 acting on the second claw portions 77. As illustrated in FIG. 4, by setting the length L1 to be shorter than the length L2, the forces F1 acting on the first claw portions 76 can be made smaller than the forces F2 acting on the second claw portions 77. This makes it easier to reduce the difference between the downward component of the resultant force of the forces F1 respectively acting on the two first claw portions 76a and 76b and the upward component of the resultant force of the forces F2 respectively acting on the two second claw portions 77a and 77b. This makes it easier to improve the coaxiality of the oil deflector 70.

However, the length L1 may coincide with the length L2 or may be longer than the length L2.

In particular, in the oil deflector 70 according to the present embodiment, the circumferential length L1 of the first claw portions 76, the circumferential length L2 of the second claw portions 77, the circumferential angle θ1 from the orthogonal axis A3 to the central portion in the circumferential direction of the first claw portions 76, and the circumferential angle θ2 from the orthogonal axis A3 to the central portion in the circumferential direction of the second claw portions 77 satisfy the relationship expressed by the following Inequation (1).

0.113×(L1×sin θ1−L2×sin θ2)<2×C (1)

Letter C in Inequation (1) denotes a clearance between the oil deflector 70 and the oil thrower member 60. Specifically, the clearance C is an ideal distance defined in design as a radial distance between the inner circumferential surface of the flat portion 72 of the oil deflector 70 and the outer circumferential surface of the first enlarged diameter portion 61 of the oil thrower member 60.

As described above, the magnitude of the force F1 acting on the first claw portions 76 is substantially proportional to the length L1. Therefore, the downward component of the force F1 acting on the first claw portions 76 is substantially proportional to L1×sin θ1. Meanwhile, the magnitude of the force F2 acting on the second claw portions 77 is substantially proportional to the length L2. Therefore, the upward component of the force F2 acting on the second claw portions 77 is substantially proportional to L2×sin θ2. Therefore, the difference between the downward component of the resultant force of the forces F1 respectively acting on the two first claw portions 76a and 76b and the upward component of the resultant force of the forces F2 respectively acting on the two second claw portions 77a and 77b is substantially proportional to (L1×sin θ1−L2×sin θ2) in the left side of Inequation (1). Therefore, the amount of deviation of the central axis A1 of the oil deflector 70 from the ideal position is substantially proportional to (L1×sin θ1−L2×sin θ2) in the left side of Inequation (1).

In order to derive Inequation (1), an actual machine test was performed. In the actual machine test, an oil deflector 70 in which the length L1, the angle θ1, the length L2, and the angle θ2 were set to specific values was prepared, and the actual amount of deviation with respect to the ideal position of the central axis A1 of the oil deflector 70 was obtained. As a result, it has been found that a value obtained by multiplying (L1×sin θ1−L2×sin θ2) in the left side of Inequation (1) by 0.113, which is a coefficient, is the amount of deviation of the central axis A1 of the oil deflector 70 from the ideal position. That is, the left side of the Inequation (1) corresponds to the amount of deviation of the central axis A1 of the oil deflector 70 from the ideal position.

In a case where the length L1, the length L2, the angle θ1, and the angle θ2 satisfy the relationship expressed by Inequation (1), the amount of deviation of the central axis A1 of the oil deflector 70 from the ideal position is smaller than twice the value of the clearance C between the oil deflector 70 and the oil thrower member 60. In this case, the coaxiality of the oil deflector 70 is small enough to avoid contact between the inner circumferential surface of the flat portion 72 of the oil deflector 70 and the outer circumferential surface of the first enlarged diameter portion 61 of the oil thrower member 60. As a result, it is possible to more effectively suppress interference between the oil deflector 70 and the oil thrower member 60, deterioration in the oil seal performance due to local increase in the clearance C between the oil deflector 70 and the oil thrower member 60, and others.

However, the length L1, the length L2, the angle θ1, and the angle θ2 may not satisfy the relationship expressed by the above Inequation (1).

Although the embodiments of the present disclosure have been described with reference to the accompanying drawings, it is naturally understood that the present disclosure is not limited to the above embodiments. It is clear that those skilled in the art can conceive various modifications or variations within the scope described in the claims, and it is understood that they are naturally also within the technical scope of the present disclosure.

The example has been explained in which the second guide surfaces 75a and 75b extend substantially parallel to the axial direction of the cylindrical portion 71 and substantially parallel to the radial direction of the cylindrical portion 71. However, the extending directions of the second guide surfaces 75a and 75b are not limited to the above example. For example, the second guide surfaces 75a and 75b may be inclined with respect to the axial direction of the cylindrical portion 71 or may be inclined with respect to the radial direction of the cylindrical portion 71. The circumferential positions of the second guide surfaces 75a and 75b in the oil deflector 70 may be modified from those in the examples of FIGS. 3 and 4.

The example in which the oil deflector 70 is mounted on the turbocharger TC has been described above. However, the device on which the oil deflector 70 is mounted may be a device other than the turbocharger TC as long as the device includes a bearing having a thrust bearing surface.

1. An oil deflector, comprising:
a cylindrical portion;
a first guide surface extending radially outward from an outer circumferential surface of the cylindrical portion, the first guide surface formed over a range greater than or equal to 180° in a circumferential direction of the cylindrical portion;
two second guide surfaces extending radially outward from the outer circumferential surface of the cylindrical portion, extending in a direction intersecting the outer circumferential surface of the cylindrical portion and the first guide surface, and connected to respective ends of the first guide surface in the circumferential direction, the two second guide surfaces arranged symmetrically with respect to a symmetry axis orthogonal to a central axis of the cylindrical portion when viewed in an axial direction of the cylindrical portion; and
a total of four claw portions including two first claw portions and two second claw portions, the two first claw portions extending radially outward from the first guide surface and, when viewed in the axial direction, arranged symmetrically with respect to the symmetry axis and having a central portion in the circumferential direction positioned on a side opposite to the second guide surface with respect to an orthogonal axis passing through the central axis and orthogonal to the symmetry axis, the two second claw portions extending radially outward from the first guide surface and, when viewed in the axial direction, arranged symmetrically with respect to the symmetry axis and having a central portion in the circumferential direction positioned on a side of the second guide surface with respect to the orthogonal axis.

2. The oil deflector according to claim 1, wherein
an angle in the circumferential direction from the orthogonal axis to the central portion in the circumferential direction of the first claw portion is greater than an angle in the circumferential direction from the orthogonal axis to the central portion in the circumferential direction of the second claw portion.

3. The oil deflector according to claim 1, wherein
a length of the first claw portion in the circumferential direction is shorter than a length of the second claw portion in the circumferential direction.

4. The oil deflector according to claim 1, wherein
the oil deflector covers an outer peripheral edge of an oil thrower member, and
a length of the first claw portion in the circumferential direction, a length of the second claw portion in the circumferential direction, an angle in the circumferential direction from the orthogonal axis to the central portion in the circumferential direction of the first claw portion, and an angle in the circumferential direction from the orthogonal axis to the central portion in the circumferential direction of the second claw portion satisfy a relationship expressed by the following Inequation (1):
0.113×(L1×sin θ1−L2×sin θ2)<2×C (1)
wherein,
L1: length of the first claw portion in the circumferential direction,
L2: length of the second claw portion in the circumferential direction,
θ1: angle in the circumferential direction from the orthogonal axis to the central portion in the circumferential direction of the first claw portion,
θ2: angle in the circumferential direction from the orthogonal axis to the central portion in the circumferential direction of the second claw portion, and
C: clearance between the oil deflector and the oil thrower member.

5. A turbocharger comprising the oil deflector according to claim 1.

6. A turbocharger comprising the oil deflector according to claim 2.

7. A turbocharger comprising the oil deflector according to claim 3.

8. A turbocharger comprising the oil deflector according to claim 4.
